(19) United States
(12) Patent Application Publication
(10) Pub. No.: US 2019/0393465 A1
(43) Pub. Date: Dec. 26, 2019

(54) SECONDARY BATTERY

(71) Applicant: NEC CORPORATION, Tokyo (JP)

(72) Inventors: Noboru YOSHIDA, Tokyo (JP); Kazuhiko INOUE, Tokyo (JP); Kenichi SHIMURA, Tokyo (JP)

(73) Assignee: NEC CORPORATION, Tokyo (JP)

(21) Appl. No.: 16/480,955

(22) PCT Filed: Jan. 25, 2018
(86) PCT No.: PCT/JP2018/002244

§ 371 Date: Jul. 25, 2019

(30) Foreign Application Priority Data
Jan. 26, 2017 (JP) 2017-011946

(51) Int. Cl. H01M 2/16; H01M 10/0525; H01M 4/525; H01M 4/62; B60L 50/64

(52) U.S. Cl. CPC H01M 2/1653; H01M 10/0525; H01M 4/525; H01M 2004/028; B60L 50/64; H01M 2220/20; H01M 4/623

(57) ABSTRACT

A purpose of one embodiment of the present invention is to provide a highly safe lithium ion secondary battery comprising a layered lithium nickel composite oxide with high nickel content and a polyethylene terephthalate separator. The first lithium ion secondary battery of the present invention is characterized by comprising a positive electrode comprising a positive electrode mixture layer and an insulation layer, and a separator comprising polyethylene terephthalate, wherein the positive electrode mixture layer comprises a layered lithium nickel composite oxide having a nickel ratio of 60 mol % or more based on metals other than lithium.

### TECHNICAL FIELD

The present invention relates to a lithium ion secondary battery, a method for manufacturing the lithium ion secondary battery and a vehicle equipped with the lithium ion secondary battery.

### BACKGROUND ART

Lithium ion secondary batteries come to be used for various applications, and there is a demand for the batteries with higher energy density than before. To increase the energy density of a battery, positive electrode active materials with high discharge capacity have been studied. In recent years, lithium nickel composite oxides are often used as high energy density positive electrode active materials. Moreover, a battery which uses a lithium nickel composite oxide having higher nickel content as a positive electrode active material is desired in order to improve the energy density of the battery. On the other hand, lithium nickel composite oxides having high nickel content also have the disadvantage of easily causing thermal runaway. In order to improve the safety of a battery, high electrical insulating properties between electrodes come to be important, and studies regarding improvement of separators and insulating layers are ongoing.

Patent document 1 discloses a battery using LiNi_{1/3}Mn_{1/3}Co_{1/3}O₂ as a positive electrode active material. In this battery, an insulating layer containing aluminum oxide is provided on the positive electrode mixture layer, and a polyethylene separator is further provided between the positive electrode and the negative electrode. Patent document 2 discloses a battery using LiNi_{0.5}Co_{0.2}Mn_{0.3}O₂ and LiCoO₂ as positive electrode active materials. In this battery, an insulating layer containing boehmite fine particles and polyethylene fine particles giving a shutdown function is provided on the negative electrode mixture layer, and a polyurethane microporous film is provided between the positive electrode and the negative electrode. However, the batteries described in these documents use lithium nickel composite oxides having low nickel content as positive electrode active materials. For this reason, they do not have sufficient energy density. Also, when a lithium nickel composite oxide having higher nickel content is used as a positive electrode active material, temperature in the battery may become high at the time of abnormality, and therefore the separator using polyethylene or polyurethane, which has a low melting point below 160° C., cannot ensure safety.

### CITATION LIST

### Patent Literature

Patent document 1: Japanese patent laid-open No. 2010-21113
Patent document 2: WO2013/136426

### SUMMARY OF INVENTION

### Technical Problem

As a result of intensive studies on a separator suitable for a lithium nickel composite oxide having high nickel content, the present inventor has found that polyethylene terephthalate is suitable. Polyethylene terephthalate is high in glass transition temperature (75° C.) and melting point (from 250° C. to 264° C.) and is excellent in heat resistance as compared with polyethylene and polyurethane as described above and other polyesters such as polybutylene terephthalate. Therefore, it can improve the safety of a battery. On the other hand, materials having further higher heat resistance, such as polyimide and polyamide, have no melting point and are inferior in processability. The separator of the lithium ion secondary battery is required to be thinned to about 30 μm or less from the viewpoint of energy density and portability. Polyethylene terephthalate can be thermally fusion-cut without generating static electricity and is suitable for thinning. In addition, polyethylene terephthalate is generally cheaper than polyimide and polyamide and is advantageous in terms of manufacturing cost.

However, polyethylene terephthalate is inferior in oxidation resistance and alkali resistance as compared with other materials, and thus has a problem of being easily deteriorated. In particular, when a battery using a layered lithium nickel composite oxide with high nickel content is overcharged, a separator containing polyethylene terephthalate is easily deteriorated. For this reason, after long-term use, a battery with a separator containing polyethylene terephthalate and a positive electrode containing a layered lithium nickel composite oxide with high nickel content still has a problem with safety.

In view of the above problems, a purpose of one embodiment of the present invention is to provide a highly safe lithium ion secondary battery comprising a layered lithium nickel composite oxide with high nickel content and a polyethylene terephthalate separator.

### Solution to Problem

The first lithium ion secondary battery of the present invention is characterized in that the lithium ion secondary battery comprises a positive electrode comprising a positive electrode mixture layer and an insulation layer, and a separator comprising polyethylene terephthalate, wherein the positive electrode mixture layer comprises a layered lithium nickel composite oxide having a nickel ratio of 60 mol % or more based on metals other than lithium.

### Advantageous Effects of Invention

According to one embodiment of the present invention, a highly safe lithium ion secondary battery using a layered lithium nickel composite oxide with high nickel content and a polyethylene terephthalate separator can be provided.

### BRIEF DESCRIPTION OF DRAWINGS

FIG. 1 is an exploded perspective view showing a basic structure of a film package battery.

FIG. 2 is a cross-sectional view schematically showing a cross section of the battery of FIG. 1.

### DESCRIPTION OF EMBODIMENTS

Hereinafter, one example of the lithium ion secondary battery of the present embodiment will be described with respect to individual elements thereof.

### <Separator>

The lithium ion secondary battery of the present embodiment comprises a separator comprising polyethylene terephthalate (PET) between a positive electrode and a negative electrode. The separator comprising polyethylene terephthalate is also referred to as a polyethylene terephthalate separator or a PET separator. The separator may have a single-layer structure or a laminated structure. In the case of a laminated structure, the separator comprises a polyethylene terephthalate layer comprising polyethylene terephthalate (PET). Preferably, the polyethylene terephthalate layer is placed on the positive electrode side and in contact with the positive electrode. The polyethylene terephthalate separator may comprise additives, such as inorganic particles, and other resin materials. The content of polyethylene terephthalate in the polyethylene terephthalate separator or the polyethylene terephthalate layer is preferably 50 weight % or more and more preferably 70 weight % or more, and may be 100 weight %.

When the separator has a laminated structure, examples of the material used in the other layer than the polyethylene terephthalate layer include, but are not particularly limited to, polyesters other than polyethylene terephthalate, such as polybutylene terephthalate and polyethylene naphthalate, polyolefins, such as polyethylene and polypropylene, aromatic polyamides (aramid), such as polymetaphenylene isophthalamide, polyparaphenylene terephthalamide and copolyparaphenylene 3,4′-oxydiphenylene terephthalamide, polyimides, polyamide imides, celluloses and the like. The separator may comprise an inorganic particle layer mainly composed of inorganic particles.

In the present embodiment, the deterioration due to oxidation or alkali, which is a drawback of polyethylene terephthalate, can be improved. For this reason, a single-layer polyethylene terephthalate separator excellent in heat resistance and processability is preferable.

The separator may be in any form including a fiber assembly such as woven fabric or non-woven fabric and a microporous film. The woven fabric and the non-woven fabric may contain a plurality of fibers different in material, fiber diameter or the like. In addition, the woven fabric and the non-woven fabric may contain a composite fiber comprising a plurality of materials. Examples of form of such composite fiber include a core-sheath type, a sea-island type, a side-by-side type and the like.

The porosity of the microporous film and the porosity (voidage) of the non-woven fabric, which are used for the separator, may be appropriately set according to characteristics of the lithium ion secondary battery. In order to obtain good rate characteristics of the battery, the porosity of the separator is preferably 35% or more, and more preferably 40% or more. Also, in order to increase the strength of the separator, the porosity of the separator is preferably 80% or less, and more preferably 70% or less.

The porosity can be calculated by the following equation:

Porosity (%)=[1−(bulk density ρ(g/cm³)/theoretical density ρ₀ of material(g/cm³))]×100,

in which bulk density is measured according to JIS P 8118.

Other measurement methods include a direct observation method using an electron microscope and a press fitting method using a mercury porosimeter.

The pore diameter of the microporous film is preferably 1 μm or less, more preferably 0.5 μm or less, and still more preferably 0.1 μm or less. Also, in the viewpoint of permeation of the charged body, the pore diameter of the microporous film is preferably 0.005 μm or more, and more preferably 0.01 μm or more.

The separator is preferably thick in terms of maintaining the insulating property and the strength. On the other hand, to increase the energy density of the battery, the separator is preferably thin. In the present embodiment, the thickness of the separator is preferably 3 μm or more, more preferably 5 μm or more, and still more preferably 8 μm or more from the viewpoint of imparting short circuit prevention and heat resistance. The thickness is preferably 40 μm or less, more preferably 30 μm or less, and still more preferably 25 μm or less in order to meet specifications, such as energy density, normally required for the battery.

### <Positive Electrode>

The positive electrode comprises a current collector; a positive electrode mixture layer, which is provided on the current collector and comprises a positive electrode active material comprising a layered lithium nickel composite oxide and a binder; and an insulating layer. In the positive electrode equipped with the insulating layer, the deterioration of the separator can be decreased because the separator is not in contact with the layered lithium nickel composite oxide.

In order to increase the energy density of the positive electrode, the positive electrode active material comprises a layered lithium nickel composite oxide having a nickel ratio of 60 mol % or more based on the metals other than lithium. The nickel ratio based on the metals other than lithium in the layered lithium nickel composite oxide is preferably 70 mol % or more, and more preferably 80 mol % or more.

Examples of a preferred layered lithium nickel composite oxide include those represented by the following formula (1).

Li_{y}Ni₍₁₋ₓ₎MₓO₂ (1)

wherein 0≤x≤0.4, 0<y≤1.2, and M is at least one element selected from the group consisting of Co, Al, Mn, Fe, Ti, and B.

Compounds represented by the formula (1) preferably have a high Ni content, that is, x is preferably 0.3 or less, further preferably 0.2 or less in the formula (1). Examples of such compounds include Li_{α}Ni_{β}Co_{γ}Mn_{δ}O₂ (0<α≤1.2, preferably 1≤α≤1.2, β+γ+δ=1, β≥0.6, and γ≤0.2) and Li_{α}Ni_{β}Co_{γ}Al_{δ}O₂ (0<α≤1.2, preferably 1≤α≤1.2, β+γ+δ=1, β≥0.6, preferably β≥0.7, and γ≤0.2) and particularly include LiNi_{β}Co_{γ}Mn_{δ}O₂ (0.75≤β≤0.85, 0.05≤γ≤0.15, and 0.10≤δ≤0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, and LiNi_{0.8}Co_{0.1}Al_{0.1}O₂ may be preferably used.

Other positive electrode active materials may be used together with the above mentioned layered lithium nickel composite oxide having a nickel ratio of 60 mol % or more based on the metals other than lithium. Examples of other positive electrode active materials include lithium manganate having a layered structure or a spinel structure such as LiMnO₂ and LiₓMn₂O₄ (0<x<2)); LiCoO₂ or materials in which a part of the transition metal in this material is replaced by other metal(s); materials in which Li is excessive as compared with the stoichiometric composition in these lithium transition metal oxides; materials having an olivine structure such as LiFePO₄, and the like. In addition, materials in which a part of these metal oxides is substituted by Al, Fe, P, Ti, Si, Pb, Sn, In, Bi, Ag, Ba, Ca, Hg, Pd, Pt, Te, Zn, La or the like are also usable.

In addition, a layered lithium nickel composite oxide having a nickel ratio of less than 60 mol % based on the metals other than lithium may be used together with the above mentioned layered lithium nickel composite oxide having a nickel ratio of 60 mol % or more based on the metals other than lithium. For example, a compound in which particular transition metals do not exceed half may be used. Examples of such compounds include Li_{α}Ni_{β}Co_{γ}Mn_{δ}O₂ (0≤α≤1.2, preferably 1≤α≤1.2, β+γ+δ=1, 0.2≤β≤0.5, 0.1≤γ≤0.4, and 0.1≤δ≤0.4). More specific examples may include LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), and LiNi_{0.5}Co_{0.3}Mn_{0.2}O₂ (abbreviated as NCM532) (also including those in which the content of each transition metal fluctuates by about 10% in these compounds).

The ratio of the layered lithium nickel composite oxide having a nickel ratio of 60 mol % or more based on the metals other than lithium is preferably 50 weight % or more, more preferably 70 weight % or more, and may be 100 weight % based on the total amount of the positive electrode active material.

As the positive electrode binder, polyvinylidene fluoride, vinylidene fluoride-hexafluoropropylene copolymer, vinylidene fluoride-tetrafluoroethylene copolymer, polytetrafluoroethylene, polypropylene, polyethylene, polyimide, polyamide imide or the like can be used. In addition to the above, styrene butadiene rubber (SBR) and the like are also exemplified. When an aqueous binder such as an SBR emulsion is used, a thickener such as carboxymethyl cellulose (CMC) can also be used. The above positive electrode binders may be mixed and used.

The amount of the binder to be used is preferably 0.5 to 20 parts by weight based on 100 parts by weight of the active material, from the viewpoint of sufficient binding strength and high energy density that are in a trade-off relation with each other.

For the positive electrode mixture layer, a conductive assisting agent may be added for the purpose of lowering the impedance. Examples of the conductive assisting agent include, flake-like, soot, and fibrous carbon fine particles and the like, for example, graphite, carbon black, acetylene black, vapor grown carbon fibers and the like.

As the positive electrode current collector, from the view point of electrochemical stability, aluminum, nickel, copper, silver, and alloys thereof are preferred. As the shape thereof, foil, flat plate, mesh and the like are exemplified. In particular, a current collector using aluminum, an aluminum alloy, or iron-nickel-chromium-molybdenum based stainless steel is preferable.

In the present embodiment, an insulating layer is provided on the positive electrode in order to prevent the deterioration of the polyethylene terephthalate separator. The insulating layer is preferably laminated on the positive electrode mixture layer. The polyethylene terephthalate separator is disposed between the positive electrode equipped with the insulating layer and the negative electrode.

Although the detailed mechanism is not clear, it is presumed that in a battery using a positive electrode containing a layered lithium nickel composite oxide with high nickel content, the polyethylene terephthalate separator deteriorates for the following reasons.

Polyethylene terephthalate is low in alkali resistance. However, since active materials with high nickel content, such as lithium nickel composite oxides used in the present embodiment, comprise large amounts of alkali components such as lithium hydroxide, lithium carbonate and lithium hydrogen carbonate as impurities, the polyethylene terephthalate is hydrolyzed by the alkalis. In addition, under an alkaline atmosphere, the redox potential of a substance is usually lowered, so it is easily oxidized. When polyethylene terephthalate, which has low oxidation resistance, is in contact with the high potential positive electrode in such a state, it may be easily oxidized.

Thus, the deterioration due to alkali derived from the lithium nickel composite oxide with high nickel content and the deterioration due to oxidation under an alkaline atmosphere are combined, and thereby deterioration of polyethylene terephthalate is considered to be accelerated. By contrast, in the present embodiment, since the insulating layer is provided on the positive electrode mixture layer, the positive electrode active material and the separator do not come in contact with each other. Therefore, the deterioration of the polyethylene terephthalate separator can be prevented.

In the case of using a separator containing a material low in both oxidation resistance and alkali resistance, such as polyethylene terephthalate, it is necessary to remove alkaline substances by a treatment such as washing or chemical reaction in order to prevent deterioration. However, in the present embodiment, the deterioration of the separator can be prevented without such a pretreatment.

Although the contact between the separator and the positive electrode can be also prevented by providing the insulating layer on the separator, the insulating layer is provided on the positive electrode in the present embodiment. The provision of the insulating layer on the positive electrode is also effective in preventing the contraction of the insulating layer. A low heat resistant resin material thermally shrinks at high temperature. When a substrate coated with an insulating layer thermally shrinks, the insulating layer also shrinks together with the substrate, causing an insulation failure. By contrast, since the positive electrode does not thermally shrink, the function of the insulating layer can be maintained even at high temperature. Although polyethylene terephthalate is a material with high heat resistance, it may melt or thermally shrink depending on temperature. By providing the insulating layer on the positive electrode rather than the separator which may thermally shrink, the safety can be enhanced.

The insulating layer comprises an insulating filler and a binder for binding the insulating filler. In the present embodiment, they preferably have oxidation resistance because the insulating layer is disposed on the positive electrode comprising a layered lithium nickel composite oxide with high nickel content.

Examples of the insulating filler include metal oxides and nitrides, specifically inorganic particles, for example, aluminum oxide (alumina), silicon oxide (silica), titanium oxide (titania), zirconium oxide (zirconia), magnesium oxide (magnesia), zinc oxide, strontium titanate, barium titanate, aluminum nitride, silicon nitride and the like, and organic particles, for example, silicone rubber. Compared to organic particles, inorganic particles have oxidation resistance and therefore are preferable in the present embodiment.

The binder is also preferably excellent in oxidation resistance, and more preferably has a smaller value of HOMO given by molecular orbital calculation. Since a polymer containing halogen such as fluorine or chlorine is excellent in oxidation resistance, it is suitable for the binder used in the present embodiment. Specific examples of such binders include polyolefins containing fluorine or chlorine, such as polyvinylidene fluoride (PVdF), polytetrafluoroethylene (PTFE), polyhexafluoropropylene (PHFP), polytrifluorinated chlorinated ethylene (PCTFE), polyp erfluoroalkoxyfluoroethylene.

In addition to these, binders generally used in an electrode mixture layer may be used.

When a water-based solvent (a solution using water or a mixed solvent mainly containing water as a dispersion medium of a binder) is used in a coating material for forming the insulating layer, which will be described later, a polymer dispersible or soluble in the water-based solvent may be used as the binder. As the polymer dispersible or soluble in the water-based solvent, for example, an acrylic resin can be exemplified. As the acrylic resin, homopolymers obtained by polymerizing one monomer, such as acrylic acid, methacrylic acid, acrylamide, methacrylamide, 2-hydroxyethyl acrylate, 2-hydroxyethyl methacrylate, methyl methacrylate, ethylhexyl acrylate, or butyl acrylate, are preferably used. Also, the acrylic resin may be a copolymer obtained by polymerizing two or more of the above monomers. Furthermore, it may be a mixture of two or more of the above homopolymers and the copolymers. In addition to the above-mentioned acrylic resin, polyolefin resins, such as styrene butadiene rubber (SBR) and polyethylene (PE), polytetrafluoroethylene (PTFE), and the like can be used. Among these, polytetrafluoroethylene (PTFE), which has high oxidation resistance, is preferred in the present embodiment. These polymers can be used singly or in combination of two or more. The form of the binder is not particularly limited, and those in the form of particles (powder) may be used as they are, or those prepared in a solution state or an emulsion state may be used. Two or more kinds of the binders may be used in different forms respectively.

The insulating layer may contain materials other than the above mentioned insulating filler and binder, if necessary. Examples of such a material include various polymer materials that can function as thickeners for the below-described coating materials for forming the insulating layer. In particular, when the water-based solvent is used, it is preferable to contain the above mentioned polymer that can function as a thickener. As the polymer functioning as the thickener, carboxymethyl cellulose (CMC) or methyl cellulose (MC) is preferably used.

The ratio of the insulating filler in the insulating layer is preferably 80 weight % or more, and more preferably 90 weight % or more. The ratio of the insulating filler in the insulating layer is preferably 99 weight % or less, and more preferably 97 weight % or less. Also, the ratio of the binder in the insulating layer is preferably 0.1 weight % or more, and more preferably 1 weight % or more. The ratio of the binder in the insulating layer is preferably 20 weight % or less, and more preferably 10 weight % or less. If the ratio of the binder is too low, the strength (shape retentively) of the insulating layer itself is lowered, and problems such as cracking and peeling may occur. If the ratio of the binder is too high, gaps between the particles in the insulating layer may become insufficient, and the ion permeability of the insulating layer may decrease in some cases. Appropriate porosity can be obtained by setting the ratios of the insulating layer and the binder within the above ranges.

In the case where a component for forming the insulating layer, for example a thickener, other than the inorganic filler and the binder is contained, the content ratio of the thickener is preferably about 10 weight % or less, preferably about 5 weight % or less, and preferably about 2 weight % or less (for example, approximately 0.5 weight % to 1 weight %).

To maintain ion conductivity, the porosity (voidage) (the ratio of the porosity volume to the apparent volume) of the insulating layer is preferably 20% or more, and more preferably 30% or more. However, when the porosity is too high, falling off or cracking occurs due to friction or shock to the insulating layer, and therefore it is preferably 80% or less, and more preferably 70% or less.

The porosity can be determined by calculating the theoretical density and the apparent density from the weight per unit area of the insulating layer, the ratios and the true specific gravity of the materials constituting the insulating layer, and the coating thickness.

Next, a method of forming the insulating layer will be described. As a material for forming the insulating layer, paste-like material (including slurry or ink state material) in which the insulating filler, the binder and a solvent are mixed and dispersed is used. This paste-like material, which forms the insulating layer, is also referred to as a coating material for forming the insulating layer.

As solvents used in the coating material for forming the insulating layer, water and a mixed solvent mainly containing water are exemplified. As solvents other than water constituting such a mixed solvent, one or two or more kinds of organic solvents (lower alcohol, lower ketone, etc.) that can be uniformly mixed with water can be selected appropriately and used. Alternatively, it may be an organic solvent such as N-methylpyrrolidone (NMP), pyrrolidone, methyl ethyl ketone, methyl isobutyl ketone, cyclohexanone, toluene, dimethylformamide, dimethylacetamide, or a combination of two or more thereof. The content of the solvent in the coating material for forming the insulating layer is not particularly limited, but it is preferably about 30 to 90 weight %, particularly about 50 to 70 weight % of the coating material as whole.

The operation of mixing the insulating filler and binder into the solvent can be carried out by using a suitable kneader such as a ball mill, a homodisper, Dispermill (registered trademark), Clearmix (registered trademark), Filmix (registered trademark), a ultrasonic disperser.

The operation of applying the coating material for forming the insulating layer can be carried out by a conventional general coating means. For example, a suitable amount of the coating material for forming the insulating layer can be applied to form a coating having a uniform thickness using a suitable coating apparatus (e.g., gravure coater, slit coater, die coater, comma coater, dip coater).

Thereafter, the coating is dried by a suitable drying means (typically at a temperature lower than the melting point of the separator, for example, 140° C. or lower, for example 30 to 110° C.), and the solvent in the coating material for forming the insulating layer may be removed.

The positive electrode of the present embodiment can be produced by preparing a slurry comprising the positive electrode active material, the binder, and a solvent, applying this on the positive electrode current collector to form the positive electrode mixture layer, and further applying the coating material for forming the insulating layer on the positive electrode mixture layer to form the insulating layer.

### <Negative Electrode>

The negative electrode comprises a current collector and a negative electrode mixture layer which is provided on the current collector and comprises a negative electrode active material and a binder.

The negative electrode active material is not particularly limited as long as it is a material capable of reversibly intercalating and deintercalating lithium ions upon charge/discharge. Specifically, metals, metal oxides, carbon and the like may be exemplified.

Examples of the metal include Li, Al, Si, Pb, Sn, In, Bi, Ag, Ba, Ca, Hg, Pd, Pt, Te, Zn, La, alloys of two or more of these and the like. Alternatively, two or more of these metals and alloys may be mixed and used. These metals and alloys may comprise one or more non-metal elements.

Examples of the metal oxide include silicon oxide, aluminum oxide, tin oxide, indium oxide, zinc oxide, lithium oxide, and composites of these. In the present embodiment, tin oxide or silicon oxide is preferably contained as a negative electrode active material of the metal oxide, and silicon oxide is more preferably contained. This is because silicon oxide is relatively stable and is unlikely to trigger a reaction with other compounds. As silicon oxide, those represented by the composition formula SiOₓ (0<x≤2) are preferred. Also, for example, 0.1 to 5 weight % of one or two or more elements selected from nitrogen, boron, and sulfur can be added to the metal oxide. In this way, the electroconductivity of the metal oxide can be enhanced.

Examples of the carbon include graphite, amorphous carbon, graphene, diamond-like carbon, carbon nanotube, and composites thereof. Here, highly crystalline graphite is highly electroconductive, and has excellent adhesion to a negative electrode current collector composed of a metal such as copper as well as voltage flatness. On the other hand, low-crystallinity amorphous carbon shows relatively small volume expansion, is thus highly effective in lessening the volume expansion of the entire negative electrode, and is unlikely to undergo degradation resulting from non-uniformity such as grain boundaries and defects.

The negative electrode binder is not particularly limited, and polyvinylidene fluoride (PVdF), vinylidene fluoride-hexafluoropropylene copolymer, vinylidene fluoride-tetrafluoroethylene copolymer, polytetrafluoroethylene, polypropylene, polyethylene, polybutadiene, polyacrylic acid, polyacrylic ester, polystyrene, polyacrylonitrile, polyimide, polyamide imide or the like may be used. Also, the negative electrode binder includes a mixture or a copolymer of a plurality of the above resins, and a cross-linked body thereof, such as styrene butadiene rubber (SBR). When an aqueous binder such as an SBR emulsion is used, a thickener such as carboxymethyl cellulose (CMC) can also be used.

The amount of the binder to be used is preferably 0.5 to 20 parts by weight based on 100 parts by weight of the active material, from the viewpoint of the sufficient binding strength and the high energy density being in a trade-off relation with each other.

From the viewpoint of improving conductivity, the negative electrode may comprise a conductive assisting agent such as carbonaceous fine particles of graphite, carbon black, acetylene black or the like.

As the negative electrode current collector, from the viewpoint of electrochemical stability, aluminum, nickel, stainless steel, chrome, copper, silver, or an alloy thereof may be used. As the shape thereof, foil, flat plate, mesh and the like are exemplified.

The negative electrode of the present embodiment may be produced, for example, by preparing a slurry comprising the negative electrode active material, the conductive assisting agent, the binder and a solvent, and applying this on the negative electrode current collector to form the negative electrode mixture layer.

### <Electrolyte Solution>

The electrolyte solution comprises a non-aqueous solvent and a supporting salt. Examples of the non-aqueous solvent include, but not particularly limited, aprotic organic solvents, for examples, cyclic carbonates such as propylene carbonate (PC), ethylene carbonate (EC) and butylene carbonate (BC); open-chain carbonates such as dimethyl carbonate (DMC), diethyl carbonate (DEC), ethyl methyl carbonate (MEC) and dipropyl carbonate (DPC); propylene carbonate derivatives; aliphatic carboxylic acid esters such as methyl formate, methyl acetate and ethyl propionate; ethers such as diethyl ether and ethyl propyl ether; phosphoric acid esters such as trimethyl phosphate, triethyl phosphate, tripropyl phosphate, trioctyl phosphate and triphenyl phosphate; and fluorinated aprotic organic solvents obtainable by substituting at least part of hydrogen atoms of these compounds with fluorine atom(s), and the like.

Among them, a cyclic or open-chain carbonate(s) such as ethylene carbonate (EC), propylene carbonate (PC), butylene carbonate (BC), dimethyl carbonate (DMC), diethyl carbonate (DEC), ethyl methyl carbonate (MEC) or dipropyl carbonate (DPC) is preferably contained.

The non-aqueous solvent may be used alone or in combination of two or more.

The supporting salt is not particularly limited except that it comprises Li. Examples of the supporting salt include LiPF₆, LiAsF₆, LiAlCl₄, LiClO₄, LiBF₄, LiSbF₆, LiCF₃SO₃, LiC₄F₉SO₃, LiC(CF₃SO₂)₃, LiN(FSO₂)₂, LiN(CF₃SO₂)₂, LiN(C₂F₅SO₂)₂, LiB₁₀Cl₁₀. In addition, the supporting salt includes lower aliphatic lithium carboxylate, chloroboran lithium, lithium tetraphenylborate, LiBr, LiI, LiSCN, LiCl and the like. The supporting salt may be used alone or in combination of two or more.

The concentration of the supporting salt in the electrolyte solution is preferably 0.5 to 1.5 mol/L. When the concentration of the supporting salt is within this range, adjustment of density, viscosity and conductivity becomes easy.

The electrolyte solution may further contain additives. The additive is not particularly limited, and examples thereof include halogenated cyclic carbonates, unsaturated cyclic carbonates, cyclic or open-chain disulfonic acid esters, and the like. These compounds can improve battery characteristics such as cycle characteristics. This is presumably because these additives decompose during charge/discharge of the lithium ion secondary battery to form a film on the surface of an electrode active material to inhibit decomposition of an electrolyte solution and a supporting salt.

### <Structure of Lithium Ion Secondary Battery>

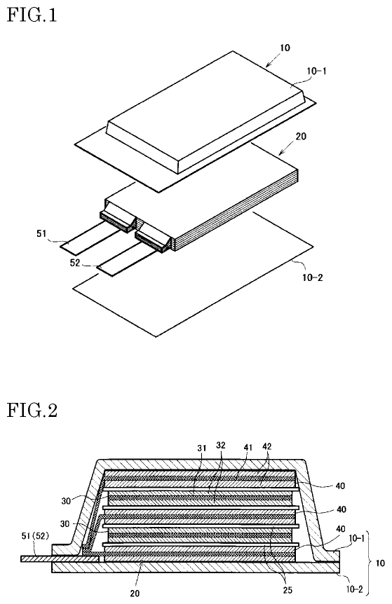

The lithium ion secondary battery according to the present embodiment, for example, has a structure as shown in FIGS. 1 and 2. This lithium ion secondary battery comprises a battery element 20, a film outer package 10 housing the battery element 20 together with an electrolyte, and a positive electrode tab 51 and a negative electrode tab 52 (hereinafter these are also simply referred to as “electrode tabs”).

In the battery element 20, a plurality of positive electrodes 30 and a plurality of negative electrodes 40 are alternately stacked with separators 25 sandwiched therebetween as shown in FIG. 2. In the positive electrode 30, an electrode material 32 is applied to both surfaces of a metal foil 31, and also in the negative electrode 40, an electrode material 42 is applied to both surfaces of a metal foil 41 in the same manner. The present embodiment is not necessarily limited to stacking type batteries and may also be applied to batteries such as a winding type.

As shown in FIGS. 1 and 2, the lithium ion secondary battery may have an arrangement in which the electrode tabs are drawn out to one side of the outer package, but the electrode tab may be drawn out to both sides of the outer package. Although detailed illustration is omitted, the metal foils of the positive electrodes and the negative electrodes each have an extended portion in part of the outer periphery. The extended portions of the negative electrode metal foils are brought together into one and connected to the negative electrode tab 52, and the extended portions of the positive electrode metal foils are brought together into one and connected to the positive electrode tab 51 (see FIG. 2). The portion in which the extended portions are brought together into one in the stacking direction in this manner is also referred to as a “current collecting portion” or the like.

The film outer package 10 is composed of two films 10-1 and 10-2 in this example. The films 10-1 and 10-2 are heat-sealed to each other in the peripheral portion of the battery element 20 and hermetically sealed. In FIG. 1, the positive electrode tab 51 and the negative electrode tab 52 are drawn out in the same direction from one short side of the film outer package 10 hermetically sealed in this manner.

Of course, the electrode tabs may be drawn out from different two sides respectively. In addition, regarding the arrangement of the films, in FIG. 1 and FIG. 2, an example in which a cup portion is formed in one film 10-1 and a cup portion is not formed in the other film 10-2 is shown, but other than this, an arrangement in which cup portions are formed in both films (not illustrated), an arrangement in which a cup portion is not formed in either film (not illustrated), and the like may also be adopted.

### <Method for Manufacturing Lithium Ion Secondary Battery>

The lithium ion secondary battery according to the present embodiment can be manufactured by a conventional method. An example of a method for manufacturing a lithium ion secondary battery will be described taking a stacked laminate type lithium ion secondary battery as an example. First, in the dry air or an inert atmosphere, the positive electrode and the negative electrode are placed to oppose to each other via a separator to form an electrode element. Next, this electrode element is accommodated in an outer package (container), an electrolyte solution is injected, and the electrodes are impregnated with the electrolyte solution. Thereafter, the opening of the outer package is sealed to complete the lithium ion secondary battery.

### <Assembled Battery>

A plurality of the lithium ion secondary batteries according to the present embodiment may be combined to form an assembled battery. The assembled battery may be configured by connecting two or more lithium ion secondary batteries according to the present embodiment in series or in parallel or in combination of both. The connection in series and/or parallel makes it possible to adjust the capacity and voltage freely. The number of the lithium ion secondary batteries included in the assembled battery can be set appropriately according to the battery capacity and output.

### <Vehicle>

The lithium ion secondary battery or the assembled battery according to the present embodiment can be used in vehicles. Vehicles according to the present embodiment include hybrid vehicles, fuel cell vehicles, electric vehicles (besides four-wheel vehicles (cars, commercial vehicles such as buses, and trucks, light automobiles, etc.), two-wheeled vehicle (bike) and tricycle), and the like. The vehicles according to the present embodiment is not limited to automobiles, it may be a variety of power source of other vehicles, such as a moving body like a train.

### EXAMPLES

### Example 1

The preparation of the battery of this example will be described.

### (Positive Electrode)

A lithium nickel composite oxide (LiNi_{0.80}Mn_{0.15}Co_{0.05}O₂) as a positive electrode active material, carbon black as a conductive assisting agent, and polyvinylidene fluoride as a binder were weighed at a weight ratio of 90:5:5, and knead with N-methylpyrrolidone to obtain a positive electrode slurry. The prepared positive electrode slurry was applied to a 20 μm-thick aluminum foil that is a current collector, dried and further pressed, and then a positive electrode was completed.

### (Preparation of Insulating Layer Slurry)

Next, alumina (average particle diameter 1.0 μm) and polyvinylidene fluoride (PVdF) that is a binder were weighed at a weight ratio of 90:10, and kneaded with N-methylpyrrolidone to obtain an insulating layer slurry.

### (Insulating Layer Coating on Positive Electrode)

The prepared insulating layer slurry was applied onto the positive electrode with a die coater, dried, and further pressed to obtain a positive electrode coated with an insulating layer. When the cross section was observed by an electron microscope, the average thickness of the insulating layer was 5 μm. Table 1 shows the porosity of the insulating layer calculated from the average thickness of the insulating layer, and the true density and the composition ratio of each material constituting the insulating layer.

(Negative Electrode)

Artificial graphite particles (average particle diameter 8 μm) as a carbon material, carbon black as a conductive assisting agent, and a 1:1 mixture by weight of styrene butadiene copolymer rubber and carboxymethyl cellulose as a binder were weighed at a weight ratio of 97:1:2 and kneaded with distilled water to obtain a negative electrode slurry. The prepared negative electrode slurry was applied to a 15 μm-thick copper foil that is a current collector, dried and further pressed, and then a negative electrode was completed.

### (Assembly of Secondary Battery)

The prepared positive electrodes and negative electrodes were stacked via a separator to obtain an electrode stack. For the separator, a single-layer PET non-woven fabric was used. This PET non-woven fabric had a thickness of 15 μm and a porosity of 55%. Here, the number of layers was adjusted such that the initial discharge capacity of the electrode stack was 100 mAh. Then the current collecting portions of each of the positive electrodes and the negative electrodes were brought together, and an aluminum terminal and a nickel terminal were welded thereto to produce an electrode element. The electrode element was packaged with a laminate film, and an electrolyte solution was injected inside the laminate film.

Subsequently, the laminate film was heat-sealed and sealed while the pressure inside of the laminate film was reduced. Thus, a plurality of flat plate type secondary batteries before initial charge was fabricated. For the laminate film, a polypropylene film on which aluminum was vapor-deposited was used. For the electrolyte solution, a solution comprising 1.0 mol/l of LiPF₆ as an electrolyte and a mixed solvent of ethylene carbonate and diethyl carbonate (7:3 (volume ratio)) as a non-aqueous solvent was used.

### (Evaluation of Secondary Battery)

### (Rate Characteristics)

The fabricated secondary battery was charged to 4.2 V and then discharged to 2.5 V at 1 C (=100 mA) to measure 1C discharge capacity. Next, the secondary battery was charged to 4.2 V again and then discharged to 2.5 V at 0.2 C (=20 mA) to measure 0.2 C discharge capacity. From these values, rate characteristics (=0.2 C discharge capacity/1 C discharge capacity) were calculated. The result is shown in Table 1.

### (High Temperature Test)

The fabricated secondary battery was charged to 4.2 V and then left to stand in a thermostat bath at 160° C. for 30 minutes. The battery did not rupture or smoke. This case was rated as ∘ (good), and the case where a battery smoked or ignited was rated as × (poor). The result is shown in Table 2.

### (Degradation of Separator due to Overcharge)

The fabricated secondary battery was charged to 5V at 1 C, left to stand for 4 weeks, and then disassembled. On the positive electrode side of the separator, no abnormality indicating signs of oxidative deterioration such as discoloration was found. This case was rated as o (good), and the case where abnormality such as discoloration was observed was rated as x (poor). The result is shown in Tables 2 and 3.

### Example 2

An insulating-coated positive electrode and a secondary battery were produced in the same manner as in Example 1 except that the ratio of the materials used in the insulating layer was set to alumina:PVdF=95:5 in weight ratio. Table 1 shows the results of the porosity of the insulating layer and rate characteristics of the fabricated battery.

### Example 3

An insulating-coated positive electrode and a secondary battery were produced in the same manner as in Example 1 except that the ratio of the materials used in the insulating layer was set to alumina:PVdF=93:7 in weight ratio. Table 1 shows the results of the porosity of the insulating layer and rate characteristics of the fabricated battery.

### Example 4

An insulating-coated positive electrode and a secondary battery were produced in the same manner as in Example 1 except that the ratio of the materials used in the insulating layer was set to alumina:PVdF=85:15 in weight ratio. Table 1 shows the results of the porosity of the insulating layer and rate characteristics of the fabricated battery.

### Example 5

An insulating-coated positive electrode and a secondary battery were produced in the same manner as in Example 1 except that the ratio of the materials used in the insulating layer was set to alumina:PVdF=80:20 in weight ratio. Table 1 shows the results of the porosity of the insulating layer and rate characteristics of the fabricated battery.

### Reference Example 1

An insulating-coated positive electrode and a secondary battery were produced in the same manner as in Example 1 except that the ratio of the materials used in the insulating layer was set to alumina:PVdF=75:25 in weight ratio. Table 1 shows the results of the porosity of the insulating layer and rate characteristics of the fabricated battery.

### Reference Example 2

An insulating-coated positive electrode and a secondary battery were produced in the same manner as in Example 1 except that the ratio of the materials used in the insulating layer was set to alumina:PVdF=70:30 in weight ratio. Table 1 shows the results of the porosity of the insulating layer and rate characteristics of the fabricated battery.

TABLE 1

| | Coating on positive electrode | | | Rate |
|---|---|---|---|---|
| | Inorganic | | Porosity | characteristics |
| | particles | Binder | (%) | (1 C/0.2 C) |
| Example 1 | Alumina (90%) | PVdF (10%) | 52 | 93 |
| Example 2 | Alumina (95%) | PVdF (5%) | 43 | 91 |
| Example 3 | Alumina (93%) | PVdF (7%) | 44 | 91 |
| Example 4 | Alumina (85%) | PVdF (15%) | 50 | 92 |
| Example 5 | Alumina (80%) | PVdF (20%) | 40 | 88 |
| Reference | Alumina (75%) | PVdF (25%) | 15 | 62 |
| example 1 | | | | |
| Reference | Alumina (70%) | PVdF (30%) | 4 | 50 |
| example 2 | | | | |

As can be seen by the results of Table 1, the porosity of the insulating layer and rate characteristics of the battery were changed according to the composition ratios of alumina and the binder PVdF in the insulating layer. As shown in Examples 1 to 5, when the concentration of PVdF was within the range of 20% or less, it was found that the porosity of the insulating layer was in a good range of about 50% and has little effect on the rate characteristics. Among these, in the case of 10% of PVdF, the porosity was the highest, and the rate characteristics were also good. On the other hand, as shown in Reference examples 1 and 2, when the concentration of PVdF was more than 20%, it was found that the porosity was significantly reduced, and as a result, the rate characteristics were reduced. This is presumably because PVdF filled pores. Therefore, the following experiments were performed with the concentration of PVdF fixed at 10%

### Example 6

A secondary battery was produced in the same manner as in Example 1 except that a material used in the insulating layer was changed from alumina to silica, and the evaluations were performed. Table 2 shows the results.

### Example 7

### (Insulating Layer Coating on Negative Electrode)

The prepared insulating layer slurry was applied onto a negative electrode produced in the same procedure as in Example 1 with a die coater, dried, and further pressed to obtain a negative electrode coated with an insulating layer. When the cross section was observed by an electron microscope, the average thickness of the insulating layer was 7 μm.

### (Assembly of Secondary Battery)

A secondary battery was produced in the same manner as in Example 1 except that the fabricated insulating-coated negative electrode was used, and the high temperature test and the overcharge test were performed. Table 2 shows the results.

### Comparative Example 1

A secondary battery was produced in the same manner as in Example 1 except that the separator was changed from PET to a polypropylene (PP), and the evaluations were performed. Table 2 shows the results.

### Comparative Example 2

A secondary battery was produced in the same manner as in Example 7 except that a positive electrode not coated with the insulating layer was used, and the evaluations were performed. The positive electrode did not have an insulating layer, and the negative electrode had an insulating layer. Table 2 shows the results.

### Comparative Example 3

A secondary battery was produced in the same manner as in Example 1 except that a positive electrode not coated with the insulating layer is used, and the evaluations were performed. Neither the positive electrode nor the negative electrode had an insulating layer. Tables 2 and 3 show the results.

### Comparative Example 4

A secondary battery was produced in the same manner as in Comparative example 3 except that the separator was changed from PET to PP, and the evaluations were performed. Table 2 shows the results.

TABLE 2

| | Coating on | Coating on | | High | |
|---|---|---|---|---|---|
| | positive | negative | | temperature | Overcharge |
| | electrode | electrode | Separator | test at 160° C. | test at 5 V |
| Example 1 | Alumina | | PET | ∘ | ∘ |
| Example 6 | Silica | | PET | ∘ | ∘ |
| Example 7 | Alumina | Alumina | PET | ∘ | ∘ |
| Comparative | Alumina | | PP | x | ∘ |
| example 1 | | | | | |
| Comparative | | Alumina | PET | ∘ | x |
| example 2 | | | | | Discoloration |
| Comparative | | | PET | ∘ | x |
| example 3 | | | | | Discoloration |
| Comparative | | | PP | x | ∘ |
| example 4 | | | | | |

As can be seen by Table 2, good results were obtained both in the high temperature test and in the overcharge test in Examples 1, 6 and 7. By contrast, as in Comparative examples 2 and 3, when PET was used in the separator and the positive electrode was not coated with an insulating layer, discoloration indicating deterioration of the separator was observed in the overcharge test. This is presumably because PET that is low in alkali resistance and oxidation resistance was in contact with a high potential positive electrode having high alkali concentration. Also, as in Comparative examples 1 and 4, when PP that is high in alkali resistance and oxidation resistance was used in the separator, the above discoloration due to overcharge was not observed, but smoke or ignition was observed in the high temperature test. This is presumably because PP had low heat resistance, the separator shrunk during the high temperature test, and the positive and negative electrodes came into contact. According to these results, it is thought that coating a positive electrode with an insulating layer and using PET in a separator yielded good results.

### Example 8

A secondary battery was produced in the same manner as in Example 1 except that the positive electrode active material was changed from LiNi_{0.80}Mn_{0.15}Co_{0.05}O₂ to LiNi_{0.60}Mn_{0.20}Co_{0.20}O₂, and the overcharge evaluation was performed. Table 3 shows the results.

### Reference Example 3

A secondary battery was produced in the same manner as in Example 1 except that the positive electrode active material was changed from LiNi_{0.80}Mn_{0.15}Co_{0.05}O₂ to LiNi_{0.50}Mn_{0.30}Co_{0.20}O₂, and the overcharge evaluation was performed. Table 3 shows the results.

### Comparative Example 5

A secondary battery was produced in the same manner as in Comparative example 3 except that the positive electrode active material was changed from LiNi_{0.80}Mn_{0.15}Co_{0.05}O₂ to LiNi_{0.60}Mn_{0.20}Co_{0.20}O₂, and the overcharge evaluation was performed. Table 3 shows the results.

### Reference Example 4

A secondary battery was produced in the same manner as in Comparative example 3 except that the positive electrode active material was changed from LiNi_{0.80}Mn_{0.15}Co_{0.05}O₂ to LiNi_{0.50}Mn_{0.30}Co_{0.20}O₂, and the overcharge evaluation was performed. Table 3 shows the results.

TABLE 3

| | Ni ratio in | Coating | |
|---|---|---|---|
| | positive | on | |
| | electrode active | positive | Overcharge |
| | material* | electrode | test at 5 V |
| Example 1 | 80 | Alumina | ∘ |
| Example 8 | 60 | Alumina | ∘ |
| Reference | 50 | Alumina | ∘ |
| example 3 | | | |
| Comparative | 80 | | x |
| example 3 | | | Discoloration |
| Comparative | 60 | | x |
| example 5 | | | Discoloration |
| Reference | 50 | | ∘ |
| example 4 | | | |

*Ni molar ratio in metals other than lithium (%)

As can be seen by Table 3, as in Reference examples 3 and 4, when the Ni ratio in the metals other than lithium in the positive electrode active material was 50 mol % or less, deterioration, such as discoloration, of the PET separator was not observed in the overcharge test regardless of whether the insulating layer was present on the positive electrode or not. This is presumably because the amount of alkali components contained in the positive electrode was small. However, these materials have a low energy density as compared with materials having a high Ni ratio, and are disadvantageous in terms of increasing the energy density of a battery. On the other hand, when using an active material with a Ni ratio of 60 mol % or more as in Comparative examples 3 and 5, discoloration of the PET separator was observed in the overcharge test. By contrast, when the insulating layer was coated on the positive electrode as in Examples 1 and 8, discoloration of the separator was not observed even though an active material with a Ni ratio of 60 mol % or more was used. According to these results, it is thought that when using a positive electrode active material with a Ni ratio of 60 mol % or more, which can be expected to increase the energy density of a battery, coating a positive electrode with an insulating layer and using PET in a separator yielded good characteristics.

This application claims priority right based on Japanese patent application No. 2017-011946, filed on Jan. 26, 2017, and the entire disclosure of which is hereby incorporated by reference.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The electrode and the battery with the electrode according to the present embodiment can be utilized in, for example, all the industrial fields requiring a power supply and the industrial fields pertaining to the transportation, storage and supply of electric energy. Specifically, it can be used in, for example, power supplies for mobile equipment such as cellular phones and notebook personal computers; power supplies for electrically driven vehicles including an electric vehicle, a hybrid vehicle, an electric motorbike and an electric-assisted bike, and moving/transporting media such as trains, satellites and submarines; backup power supplies for UPSs; and electricity storage facilities for storing electric power generated by photovoltaic power generation, wind power generation and the like.

### EXPLANATION OF SYMBOLS

10 film outer package
20 battery element
25 separator
30 positive electrode
40 negative electrode

1. A lithium ion secondary battery comprising a positive electrode comprising a positive electrode mixture layer and an insulation layer, and a separator comprising polyethylene terephthalate, wherein the positive electrode mixture layer comprises a layered lithium nickel composite oxide having a nickel ratio of 60 mol % or more based on metals other than lithium.

2. The lithium ion secondary battery according to claim 1, wherein the lithium nickel composite oxide is represented by the following formula,
Li_{y}Ni₍₁₋ₓ₎MₓO₂
wherein 0≤x≤0.4, 0<y≤1.2, and M is at least one element selected from the group consisting of Co, Al, Mn, Fe, Ti, and B.

3. The lithium ion secondary battery according to claim 1, wherein the insulating layer comprises an insulating filler and a binder, wherein a ratio of the insulating filler in the insulating layer is 80 weight % or more, and a ratio of the binder in the insulating layer is 20 weight % or less.

4. The lithium ion secondary battery according to claim 3, wherein the binder is a polyolefin containing fluorine or chlorine.

5. The lithium ion secondary battery according to claim 1, wherein a porosity of the insulating layer is 20% or more.

6. The lithium ion secondary battery according to claim 1, wherein the separator is a single-layer polyethylene terephthalate separator.

7. The lithium ion secondary battery according to claim 1, wherein the positive electrode mixture layer comprises an alkali component.

8. A vehicle equipped with the lithium ion secondary battery according to claim 1.

9. A method for manufacturing a lithium ion secondary battery, comprising the steps of:
fabricating an electrode element by stacking a positive electrode and a negative electrode via a separator, and
enclosing the electrode element and an electrolyte solution into an outer package,
wherein the positive electrode comprises a positive electrode mixture layer and an insulation layer, wherein the positive electrode mixture layer comprises a layered lithium nickel composite oxide having a nickel ratio of 60 mol % or more based on metals other than lithium, and the separator comprises polyethylene terephthalate.
